(19) United States
(12) Patent Application Publication
(10) Pub. No.: US 2025/0363958 A1
(43) Pub. Date: Nov. 27, 2025

(54) DISPLAY DEVICE AND ELECTRONIC DEVICE INCLUDING THE SAME

(71) Applicant: SAMSUNG DISPLAY CO., LTD., YONGIN-SI (KR)

(72) Inventors: KI HYUN PYUN, YONGIN-SI (KR); JUNG EON AN, YONGIN-SI (KR)

(21) Appl. No.: 19/019,555

(22) Filed: Jan. 14, 2025

(30) Foreign Application Priority Data
May 21, 2024 (KR) 10-2024-0066048

(51) Int. Cl. G09G 3/3275; G09G 3/32

(52) U.S. Cl. CPC G09G 3/3275; G09G 3/32; G09G 2310/0275; G09G 2310/0291; G09G 2310/08; G09G 2320/0271; G09G 2330/021; G09G 2330/025; G09G 2360/16

(57) ABSTRACT

A display device and an electronic device including the display device are configured to increase a data slew rate of a pixel block having a relatively low data charging rate. The display device includes a display panel including data lines and pixel blocks connected to the data lines, data drivers for supplying data signals to the data lines, and a timing controller for controlling the data drivers. Each of the data drivers adjusts slew rates of the data signals, based on a maximum grayscale value of an image displayed through the pixel blocks and positions of the pixel blocks relative to the display panel, and the timing controller calculates the maximum grayscale value of the image, based on an input grayscale value, an input luminance value, and a load value of each of the pixel blocks, which are calculated based on input image data.

### CROSS-REFERENCE TO RELATED APPLICATION

The present application claims priority under 35 U.S.C. § 119 (a) to Korean patent application No. 10-2024-0066048 filed on May 21, 2024 in the Korean Intellectual Property Office, the entire disclosure of which is incorporated by reference herein.

### FIELD

The present disclosure generally relates to display devices and electronic devices including the same.

### INTRODUCTION

A display device may transmit various data to generate a data signal through an intra-panel interface built between a timing controller (T-CON) and a source driver (S-IC).

The source driver (S-IC) may supply a data signal to a display panel of the display device, and data charging might not be sufficiently provided as an output grayscale value if the data signal becomes higher. In addition, a data charge rate may vary based on a position of a pixel or pixel block on the display panel. Accordingly, the quality of an image displayed by the display device and an electronic device including the display device might deteriorate.

The above introduction is provided by the inventors to enhance understanding of the present disclosure, and therefore it may contain information that does not constitute prior art to the claimed invention.

### SUMMARY

Embodiments provide a display device and an electronic device, in which the slew rate of a data signal is controlled based on positions of pixel blocks within a display panel and a maximum grayscale value of an image which the pixel blocks actually output, thereby optimizing an image quality of the display device.

In accordance with an embodiment of the present disclosure, a display device includes: a display panel including data lines and pixel blocks connected to the data lines; data drivers configured to supply data signals to the data lines; and a timing controller configured to control the data drivers, wherein each of the data drivers is configured to adjust slew rates of the data signals, based on a maximum grayscale value of input image data to be displayed through the pixel blocks and positions of the pixel blocks relative to the display panel, and wherein the timing controller is configured to calculate the maximum grayscale value of the image, based on an input grayscale value of the input image data, an input luminance value of the input image data, and a load value of each of the pixel blocks. Each of the data drivers may include: an output buffer configured to output any one of the data signals to any one of the data lines; a current supplier configured to supply a bias current to the output buffer; a current controller configured to adjust an intensity of the bias current, based on the maximum grayscale value of the image; and a data output controller configured to adjust an output timing of any one of the data signals, based on the maximum grayscale value of the image.

The current controller may increase the intensity of the bias current as the maximum grayscale value becomes larger. The data output controller may delay the output timing of any one of the data signals as the maximum grayscale value becomes larger.

The pixel blocks may include: a first pixel block disposed adjacent to any corner of the display panel; and a second pixel block disposed adjacent to the first pixel block. The maximum grayscale value of each of the first pixel block and the second pixel block may have any one of a first grayscale value, a second grayscale value, and a third grayscale value.

The current controller may be configured to supply any one of a first bias current, a second bias current, and a third bias current to each of a first output buffer corresponding to the first pixel block and a second output buffer corresponding to the second pixel block. The data output controller may output the data signals supplied to the first pixel block and the second pixel block at any one of a first time point, a second time point, and a third time point.

When the maximum grayscale value of the first pixel block is the first grayscale value, the current controller may be configured to supply the first bias current to the first output buffer, and the data output controller may output the data signal supplied to the first pixel block at the first time point.

When the maximum grayscale value of the first pixel block is the second grayscale value greater than the first grayscale value, the current controller may be configured to supply the second bias current greater than the first bias current to the first output buffer, and the data output controller may output the data signal supplied to the first pixel block at the second time point later than the first time point.

When the maximum grayscale value of the first pixel block is a third grayscale value greater than the second grayscale value, the current controller may be configured to supply the third bias current greater than the second bias current to the first output buffer, and the data output controller may output the data signal supplied to the first pixel block at the third time point later than the second time point.

When the maximum grayscale value of the second pixel block is the second grayscale value, the current controller may be configured to supply the first bias current to the second output buffer, and the data output controller may output the data signal supplied to the second pixel block at the first time point. When the maximum grayscale value of the second pixel block is the third grayscale value, the current controller may be configured to supply the second bias current to the second output buffer, and the data output controller may output the data signal supplied to the second pixel block at the second time point. The pixel blocks may further include a third pixel block disposed more

adjacent to the first pixel block than the second pixel block. The data drivers may independently control the first through third pixel blocks.

The current controller may be configured to supply the first bias current to a third output buffer corresponding to the third pixel block. The data output controller may output the data signal supplied to the third pixel block at the first time point.

The timing controller may calculate the maximum grayscale value to be in inverse proportion to the input grayscale value, the input luminance value, and the load value.

In accordance with an embodiment of the present disclosure, a display device includes: a display panel including data lines and pixel blocks connected to the data lines; data drivers configured to supply data signals to the data lines; and a timing controller configured to supply frame data to the data drivers, wherein the frame data includes a data slew rate option based on a maximum grayscale value expressed through the pixel blocks and positions of the pixel blocks relative to the display panel.

The timing controller may include: a grayscale analyzer configured to calculate an input grayscale value of each of the pixel blocks, based on input image data; and a load calculator configured to calculate an input luminance value and a load value of each of the pixel blocks, based on the input image data.

The timing controller may further include an output grayscale calculator configured to calculate the maximum grayscale value, based on the input grayscale value, the input luminance value, and the load value, of each of the pixel blocks.

The output grayscale calculator may calculate the maximum grayscale value to be in inverse proportion to the input grayscale value, the input luminance value, and the load value.

The timing controller may include: a memory configured to store a lookup table including bias current data supplied to the data lines and output timing data of the data signals; and a data slew rate determiner configured to determine a data slew rate option corresponding to the maximum grayscale value, based on the lookup table.

Each of the data drivers may include: an output buffer configured to output any one of the data signals to any one of the data lines; a current supplier configured to supply a bias current to the output buffer; a current controller configured to adjust an intensity of the bias current, based on the data slew rate option; and a data output controller configured to adjust an output timing of any one of the data signals, based on the data slew rate option.

In accordance with an embodiment of the present disclosure, an electronic device includes: a processor configured to provide a display device with a digital signal including frame data; and a display device configured to display an image, based on the digital signal, wherein the display device includes: a display panel including data lines and pixel blocks connected to the data lines; and data drivers configured to supply data signals to the data lines, and wherein the frame data includes a data slew rate option based on a maximum grayscale value of an image expressed through the pixel blocks and positions of the pixel blocks relative to the display panel.

### BRIEF DESCRIPTION OF THE DRAWINGS

Illustrative embodiments will now be described more fully hereinafter with reference to the accompanying drawings. It shall be understood that embodiments may take different forms and should not be construed as limited to the embodiments set forth herein. Rather, these embodiments are provided by way of example so that this disclosure will be thorough and complete, and will fully convey the scope of the inventive concept to those of ordinary skill in the pertinent art.

In the drawings provided, dimensions may be exaggerated for clarity of illustration. It will be understood that when an element is referred to as being “between” two elements, it can be the only element between the two elements, or one or more intervening elements may also be present. Like reference numerals may refer to like elements throughout.

FIG. 1 is a schematic diagram illustrating a display device in accordance with an embodiment of the present disclosure.

FIG. 2 is a block diagram illustrating an embodiment of a timing controller and data driver ICs (DDIC), which are included in the display device shown in FIG. 1.

FIG. 3 is a block diagram illustrating an embodiment of any one of the data driver ICs shown in FIG. 2.

FIG. 4 is a signal diagram illustrating an example of a signal supplied from the timing controller to a data driver, which are shown in FIG. 2.

FIG. 5 is a block diagram illustrating an embodiment of a data signal generator shown in FIG. 3.

FIG. 6A is a block diagram illustrating an embodiment of a current controller, a current supplier, an output buffer, and a data output controller, which are shown in FIG. 5.

FIG. 6B is a circuit diagram illustrating an embodiment of the current controller, the current supplier, the output buffer, and the data output controller, which are shown in FIG. 5.

FIG. 7 is a waveform diagram illustrating waveforms of a data signal based on intensity of bias current.

FIG. 8 is a waveform diagram waveforms of a data signal based on data output timing.

FIG. 9 is a hybrid diagram illustrating a data slew rate control operation based on control of bias current.

FIG. 10 is a hybrid diagram illustrating a data slew rate control operation based on bias current and data signal output timing control.

FIG. 11 is a block diagram illustrating a timing controller in accordance with an embodiment of the present disclosure.

FIG. 12 is a tabular diagram illustrating an embodiment of a lookup table shown in FIG. 11.

FIG. 13 is a plan view diagram illustrating pixel blocks corresponding to the data driver ICs in accordance with an embodiment of the present disclosure.

FIG. 14 is a tabular diagram illustrating an embodiment of bias current data included in the lookup table shown in FIG. 12.

FIG. 15 is a tabular diagram illustrating an embodiment of output timing data included in the lookup table shown in FIG. 12.

FIG. 16 is a tabular diagram illustrating an embodiment of bias currents and output timings of a data signal based on maximum grayscale values of first through third pixel blocks.

FIG. 17 is a tabular diagram illustrating an embodiment of the bias currents and the output timings of the data signal based on the maximum grayscale values of the first through third pixel blocks.

FIG. 18 is a block diagram illustrating an electronic device including a display device in accordance with embodiments of the present disclosure.

### DETAILED DESCRIPTION

Hereinafter, embodiments of the present disclosure will be described in greater detail with reference to the accompanying drawings. For brevity of description, information that is sufficient for those of ordinary skill in the pertinent art to understand an inventive elements or operative steps according to the present disclosure may be described, while descriptions of other elements or steps may be omitted in order not to unnecessarily obscure inventive subject matter of the present disclosure. In addition, the present disclosure is not limited to the embodiments described herein, but may be embodied in various different forms. Illustrative embodiments described herein are provided to thoroughly and completely describe the disclosed contents by way of non-limiting example and to sufficiently transfer the ideas of the disclosure to a person of ordinary skill in the pertinent art.

In the entire specification, when an element is referred to as being “connected” or “coupled” to another element, it can be directly connected or coupled to the other element or be indirectly connected or coupled to the other element with one or more intervening elements interposed therebetween. The technical terms used herein are used only for the purpose of describing a specific embodiment, and are not intended to limit this embodiment inventive concept. It will be understood that when a component “includes” an element, unless there is another opposite description thereto, it should be understood that the component does not exclude another element but may further include another element. It will be understood that for the purposes of this disclosure, “at least one of X, Y, and Z” can be construed as X only, Y only, Z only, or any combination of two or more items X, Y, and Z (e.g., XYZ, XYY, YZ, ZZ, or the like). Similarly, for the purposes of this disclosure, “at least one selected from the group consisting of X, Y, and Z” can be construed as X only, Y only, Z only, or any combination of two or more items X, Y, and Z (e.g., XYZ, XYY, YZ, ZZ, or the like).

It will be understood that, although the terms “first”, “second,” or the like may be used herein to describe various elements, these elements should not be construed as limited by these terms. These terms are only used to distinguish one element from another element. Thus, a “first” element described below could also be termed a “second” element without departing from the teachings of the present disclosure.

Spatially relative terms, such as “below,” “above,” and the like, may be used herein for ease of description to describe the relationship of one element to another element, as illustrated in the figures. It will be understood that the spatially relative terms, as well as the illustrated configurations, are intended to encompass different orientations of the apparatus in use or operation in addition to the orientations described herein and depicted in the figures. For example, if the apparatus in the figures is turned over, elements described as “below” or “beneath” other elements or features would then be oriented “above” the other elements or features. Thus, the spatially relative term, “above,” may encompass both an orientation of above and below. The apparatus may be otherwise oriented (e.g., rotated 90 degrees or at other orientations) and the spatially relative descriptors used herein interpreted accordingly.

In addition, the embodiments of the disclosure are described herein with reference to schematic diagrams of illustrative embodiments, as well as intermediate structure of the present disclosure, so that changes in a shape as shown due to, for example, manufacturing technology and/or a tolerance may be expected. Therefore, the embodiments of the present disclosure shall not be limited to the specific shapes of a region shown or described herein, but include shape deviations caused by, for example, the manufacturing technology and/or application criteria. The regions shown in the drawings are schematic in nature, and the shapes thereof need not represent the actual shapes of the regions of the device, and do not limit the scope of the disclosure.

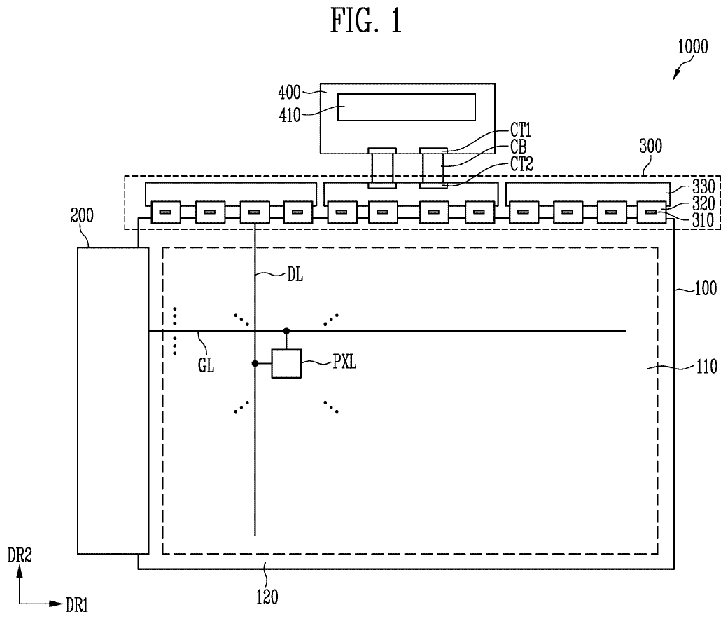

FIG. 1 illustrates a display device in accordance with an embodiment of the present disclosure. In FIG. 1, a display device having a plurality of data driver ICs is illustrated as an embodiment applicable in the present disclosure. However, the present disclosure is not limited thereto. For example, the present disclosure may be applied to a display device having just one data driver IC.

Referring to FIG. 1, the display device 1000 may include a display panel 100, which may also be referred to as a display unit 100 or a pixel unit 100, a gate driver 200, a data driver 300, which may also be referred to as a source driver 300, a data driving circuit 300 or the like, and a timing controller 410. The data driver 300 may include at least one data driver IC 310, which may also be referred to as a source driver IC 300.

The display panel 100 may include a display area 110 in which an image is displayed and a non-display area 120 located at the periphery of the display area 110, such as in an edge area. In the display panel 100, gate lines GL, data lines DL, pixels PXL, and the like may be disposed in the display area 110.

The gate lines GL may extend in a first direction DR1, and be arranged along a second direction DR2. The data lines DL may extend in the second direction DR2, and be arranged along the first direction DR1.

Each pixel PXL may be connected to a gate line GL and to a data line DL, and emit light with a luminance corresponding to a data signal (e.g., a data voltage) in response to a gate signal. Each gate signal may be provided through a respective gate line GL, and each data signal may be provided through a respective data line DL.

Each pixel PXL may include at least one light emitting element and a pixel circuit for driving the light emitting element. The pixel circuit may include, for example, a switching transistor for transferring a data signal in response to a gate signal, a storage capacitor for storing the data signal transferred through the switching transistor, a driving transistor for providing a driving current to the at least one light emitting element, corresponding to the stored data signal, and the like. The light emitting element may include an organic light emitting diode, an inorganic light emitting diode, or the like. However, the present disclosure is not limited thereto. For example, the light emitting element may include a quantum dot light emitting diode or the like.

The timing controller 410 may control the gate driver 200 and the at least one data driver IC 310. The timing controller 410 may receive a control signal from an external source (e.g., a processor), and generate a gate control signal and a data control signal based on the control signal. The control signal may include a vertical synchronization signal, a horizontal synchronization signal, an external clock signal, and the like. The timing controller 410 may provide the gate control signal to the gate driver 200, and provide the data control signal to the data driver IC 310.

In addition, the timing controller 410 may generate input image data by realigning input data or original image data provided from the external source, and provide the input image data to the data driver IC 310. The timing controller 410 may be mounted on a control board 400. The control board 400 may include a Control Printed Circuit Board (CPCB).

The gate driver 200 and the data driver IC 310 may drive the display panel 100. The gate driver 200 may receive the gate control signal from the timing controller 410.

The gate driver 200 may generate gate signals, based on the gate control signal. The gate driver 200 may provide the generated gate signals to the display panel 100. The gate control signal may include a start pulse and a clock signal (e.g., a scan clock signal and/or a carry clock signal).

The gate driver 200 may generate a gate signal corresponding to the start pulse, using the clock signal, and provide the gate signal to the gate line GL. For example, the gate driver 200 may include a shift register which sequentially shifts and outputs the start pulse.

In an embodiment, the gate driver 200 may be divided into two or more drivers divided physically and/or logically from each other, and the drivers may be disposed at one side of the display panel 100 and at another side of the display panel 100, which is opposite to the one side. As such, the gate driver 200 may be disposed at the periphery of the display panel 100 in various forms of an embodiment.

The gate driver 200 may be connected to the timing controller 410. For example, the gate driver 200 may be connected to the timing controller 410 mounted on the control board 400 via at least one data driver sub-circuit film 320, source driver circuit film, or flexible circuit board; at least one data printed circuit board 330 or source printed circuit board; and/or at least one cable circuit board (CB) or flexible printed circuit board. However, the present disclosure is not limited thereto.

The data driver IC 310 may receive a data control signal and image data from the timing controller 410. Accordingly, the data driver IC 310 may generate a data signal corresponding to the image data. The data driver IC 310 may provide the generated data signal to the display panel 100. The data driver IC 310 may be mounted on the data driver sub-circuit film 320. The data driver IC 310 may be connected to the timing controller 410 via the at least one data printed circuit board 330 and/or the cable CB.

In an embodiment, the data driver IC 310 may adjust a slew rate of a data signal provided to the data line DL. The slew rate may be defined as a change of voltage per unit time. In the data driver IC 310, the slew rate may indicate a speed at which the voltage of a data signal changes in response to an input signal.

The at least one cable CB may electrically connect the control board 400 and the at least one data printed circuit board 330 to each other through upper and lower connectors CT1 and CT2. The cable CB inclusively means a device having a line capable of connecting the control board 400 and the data printed circuit board 330, and the like. For example, the cable CB may be implemented as a flexible circuit board.

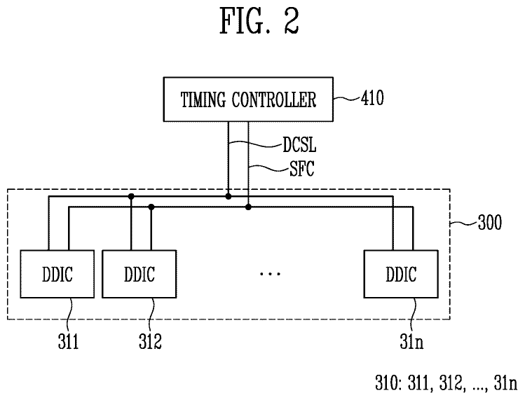

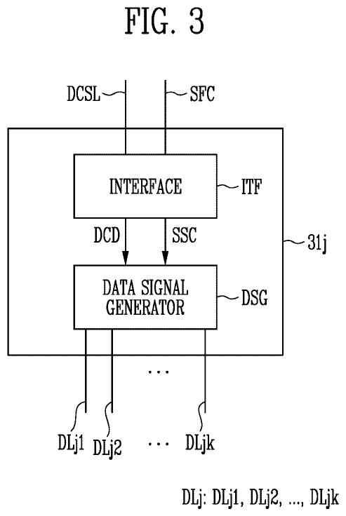

FIG. 2 illustrates an embodiment of the timing controller and the data driver ICs, which may be included in the display device shown in FIG. 1. FIG. 3 illustrates an embodiment of any one of the data driver ICs shown in FIG. 2.

Referring to FIGS. 1 and 2, the data driver 300 may include data driver ICs 310. Each of the data driver ICs 310 may be referred to as a driver IC or a source IC.

Referring to FIGS. 1 through 3, the at least one data driver IC 310 may include first through nth data driver sub-circuits 311 through 31n (where n is an integer of one or more). Each of the first through nth data driver sub-circuits 311 through 31n may be connected to at least one data line among data lines. For example, a jth data driver sub-circuit 31j (where j is an integer of one or more) may be connected to first through kth data lines DLj1 through DLjk (where k is an integer of one or more). In other words, the data lines DL may be grouped, and each data line group may be connected to a corresponding data driver IC 310. For example, a data line group may include k data lines DL, and each of the first through nth data driver sub-circuits 311 through 31n may be connected to k data lines.

The timing controller 410 and the data driver 300 may be connected to each other through a data clock signal line DCSL and a shared signal line SFC.

The timing controller 410 may be connected to each of the data driver ICs 310 through the data clock signal line DCSL. For example, a method in which the timing controller 410 is connected to the data driver ICs 310 through the data clock signal line DCSL may be a point-to-point method. In the above embodiment, the data clock signal line DCSL may include sub-data clock signal lines respectively corresponding to the data driver ICs 310. The timing controller 410 may be connected to the data driver ICs 310 through the sub-data clock signal lines, respectively. However, the present disclosure is not limited thereto.

Since the timing controller 410 and the data driver ICs 310 are connected to each other through the data clock signal line DCSL, the timing controller 410 may provide a data control signal corresponding to each of the data driver ICs 310 through the data clock signal line DCSL. The data control signal may include a clock training signal and image data.

The timing controller 410 may be commonly connected to the data driver ICs 310 included in the data driver 300 through the shared signal line SFC. For example, a method in which the timing controller 410 is connected to the data driver ICs 310 included in the data driver 300 through the shared signal line SFC may be a multi-drop method. The timing controller 410 may simultaneously transfer, to the data driver ICs 310, a notification signal indicating that a clock training pattern is to be supplied through one shared signal line SFC. However, the present disclosure is not limited thereto.

In an embodiment, the shared signal line SFC may correspond to a bidirectional signal transmission channel formed between the timing controller 410 and the data driver 300 (or the data driver ICs 310). However, the present disclosure is not limited thereto.

Referring to FIG. 3, the data driver IC 310 may include an interface ITF and a data signal generator DSG. In FIG. 3, for convenience of description, the jth data driver sub-circuit 31j may be any one of the data driver ICs 310 of the data driver 300, or a sub-circuit thereof.

The interface ITF may receive a clock data signal from the timing controller 410 through the data clock signal line DCSL. The interface ITF may receive a clock training signal from the timing controller 410 through the shared signal line SFC.

The interface ITF may comply with a predetermined interface standard and/or physical layer protocol standard (D-PHY) standard. For example, an interface ITF which mediates data transmission/reception between the timing controller 410 and the data driver IC 310 may be an intra-panel interface of a Unified Standard Interface for TV (USI-T). However, this is merely illustrative, and the form of the interface ITF is not limited thereto.

The interface ITF may generate a clock signal, using the clock training signal and the clock data signal, and sample image data DCD from the clock data signal, using the generated clock signal. The interface ITF may provide the sampled image data DCD to the data signal generator DSG. In addition, the interface ITF may provide a source shift clock SSC to the data signal generator DSG.

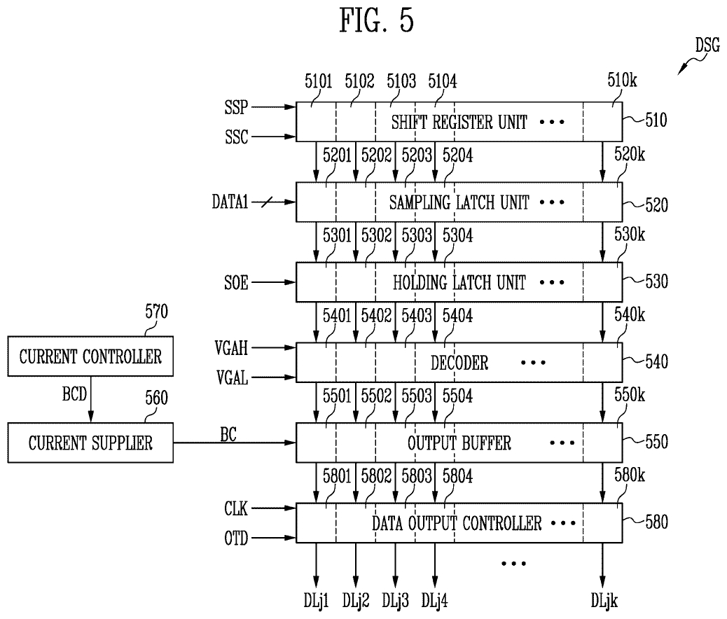

The data signal generator DSG may receive the image data DCD and the source shift clock SSC from the interface ITF. The data signal generator DSG may generate data signals, such as data voltages, using the source shift clock SSC and the image data DCD. In an embodiment, the source shift clock SSC may include a source shift pulse SSP (see FIG. 5, described infra).

The data signal generator DSG may be synchronized with a period in which a gate signal having a turn-on level is applied to a gate line, to apply to the data lines DLj data signals corresponding to grayscale values of pixels PXL (see FIG. 1, described supra) connected to the corresponding gate line.

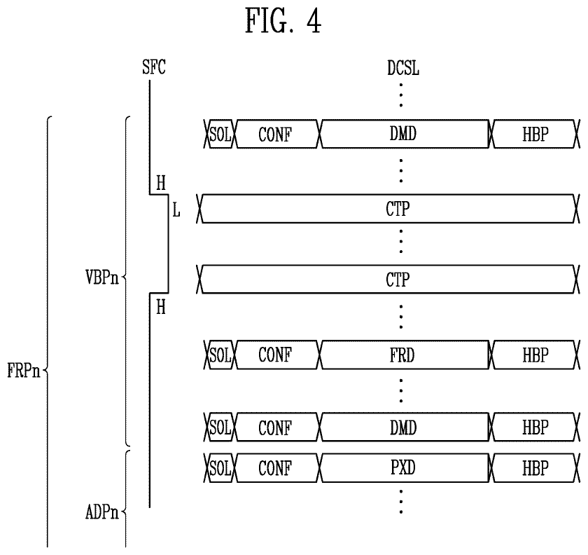

FIG. 4 illustrates an example of a signal supplied from the timing controller to the data driver, which are shown in FIG. 2. FIG. 5 illustrates an embodiment of the data signal generator shown in FIG. 3.

Referring to FIG. 4, a frame period of each image frame may include a vertical blank period and an active data period. For example, an nth frame period FRPn may include an nth vertical blank period VBPn and an nth active data period ADPn.

The active data period ADPn may be a supply period of grayscale values constituting an image frame which the display panel 100 is to display. The grayscale values may be included in pixel data PXD or image data.

The vertical blank period VBPn may be occur prior to the active data period ADPn of a current frame. During the vertical blank period VBPn, clock training, frame setting, and supplying dummy data may be performed. The vertical blank period VBPn may include (e.g., sequentially) a supply period of dummy data DMD such as while a logic level of the shared signal line SFC is high, a supply period of a clock training pattern CTP while SFC is low, as well as a supply period of frame data FRD and a supply period of dummy data DMD while SFC is high.

For example, the timing controller 410 may apply a clock training signal having a low logic level L to the shared signal line SFC during the vertical blank period VBPn to notify the data driver 300 that the clock training pattern CTP is being supplied to the data clock signal line DCSL. The timing controller 410 may apply a clock training signal having a high logic level H to the shared signal line SFC when the clock training pattern CTP is not supplied.

In the active data period ADPn, a start of line SOL, a line configuration CONF, image data (e.g., pixel data PXD, frame data FRD, or dummy data DMD), and a horizontal blank period HBP may be sequentially supplied in a pixel row unit. The start of line SOL may function to notify the data driver IC 310 that the supply of a signal to a changed pixel row has started.

The frame data FRD may include information regarding a slew rate of a data signal in a frame unit. Accordingly, the data signal generator DSG may adjust slew rates of data signals, based on the frame data FRD.

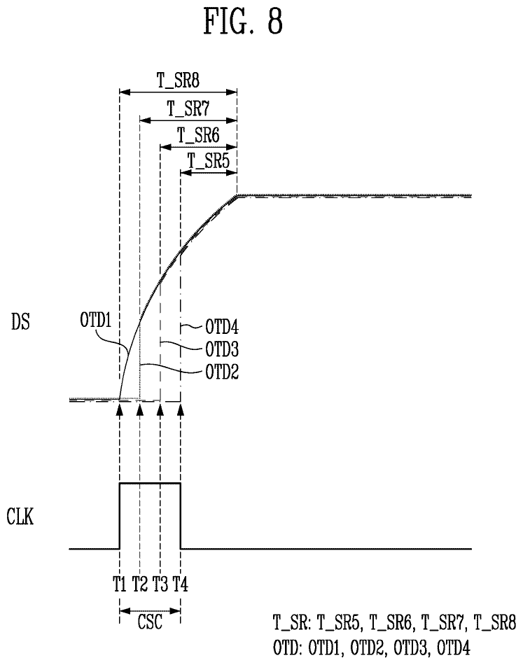

The frame data FRD may be data after synchronization is completed. In other words, the frame data FRD may be synchronized by a clock training signal. Accordingly, the frame data FRD may control the output of a data signal at a time interval smaller than a clock signal period CSC (see FIG. 8, described infra) of a clock signal CLK. This may be described in greater detail with reference to FIG. 8.

The horizontal blank period HBP may function to notify the data driver IC 310 that a pixel row (e.g., pixels connected to a same gate line) corresponding to image data, such as the pixel data PXD, is changed.

The line configuration CONF may include an operation option of the data driver IC 310. For example, the line configuration CONF may indicate that subsequent data is pixel data PXD, or that subsequent data is dummy data DMD, without limitation thereto.

FIG. 5 illustrates an embodiment of the data signal generator shown in FIG. 3.

Referring to FIG. 5, the data signal generator DSG may include a shift register unit 510, a sampling latch unit 520, a holding latch unit 530, a decoder 540, an output buffer 550, and the like.

The shift register unit 510 may receive a source start pulse SSP and a source shift clock SSC. The shift register unit 510 may sequentially generate k sampling signals in response to the source start pulse SSP and the source shift clock SSC. For example, the shift register unit 510 may sequentially generate the k sampling signals by shifting the source start pulse SSP for each cycle of the source shift clock SSC. The shift register unit 510 may include k shift registers 5101 through 510k, where k is a natural number greater than zero.

The sampling latch unit 520 may sequentially latch or store input image data DATA1 in response to the sampling signals sequentially supplied from the shift register unit 510. The sampling latch unit 520 may include k sampling latches 5201 through 520k configured to store k input image data signals DATA1.

The holding latch unit 530 may latch or store the input image data signals DATA1 supplied from the sampling latch unit 520 in response to a source output enable signal SOE. The holding latch unit 530 may supply the stored input image data signals DATA1 to the decoder 540. The holding latch unit 530 may include k holding latches 5301 through 530k.

The decoder 540 may convert the input image data signals DATA1 output from the holding latch unit 530 into an analog signal (e.g., an analog voltage). The decoder 540 may output the converted analog signal to the output buffer 550. The decoder 540 may receive a minimum grayscale gamma voltage VGAL and a maximum grayscale gamma voltage VGAH. The decoder 540 may select grayscale voltages corresponding to the input image data signals DATA1 input from the holding latch unit 530, based on the minimum grayscale gamma voltage VGAL and the maximum grayscale gamma voltage VGAH. The decoder 540 may include k digital-to-analog converters 5401 through 540k. The decoder 540 may generate k data voltages, using the digital-to-analog converters 5401 through 540k disposed corresponding to each channel (e.g., each data line), and supply the generated data voltages to the output buffer 550.

The output buffer 550 may supply the k data signals (e.g., data voltages) supplied from the decoder 540 to k data lines DLj1 through DLjk. The output buffer 550 may include k output buffers 5501 through 550k.

A current supplier 560 may be supplied with bias current data BCD from a current controller 570 to generate a bias current BC. For example, the current supplier 560 may generate the bias current BC having an intensity corresponding to the bias current data BCD. The current supplier 560 may supply the generated bias current BC to the output buffer 550. Although one current supplier 560 is illustrated as configured in FIG. 5, k current suppliers 560 may be configured. In other words, the k current suppliers 560 may supply the bias current BC to corresponding output buffers 5501 through 550k.

In an embodiment, the bias current BC may be replaced or supplemented with a bias signal such as a bias voltage. In other words, according to a form of the output buffer 550, the current supplier 560 may generate a bias value (e.g., a current and/or a voltage) in a form suitable for the form of the output buffer 550.

Referring to FIGS. 4 and 5, the current controller 570 may receive a signal indicative of the intensity of the bias current BC from the timing controller 410 (see FIG. 2, described supra). For example, the timing controller 410 may transfer frame data FRD to the data driver IC 310. The frame data FRD may include information regarding a slew rate of a data signal, and the slew rate of the data signal may be controlled based on the intensity of the bias current BC. Accordingly, the current controller 570 may generate bias current data BCD for controlling the intensity of the bias current BC, based on the frame data FRD. The current controller 570 may transfer the generated bias current data BCD to the current supplier 560.

A data output controller 580 may control output timing of each of the k data signals (e.g., data voltages) received from the output buffer 550. For example, the data output controller 580 may include k data output controllers 5801 through 580k. Each of the k data output controllers 5801 through 580k may be supplied with a clock signal CLK and output timing data OTD. Accordingly, the k data output controllers 5801 through 580k may control output timings of the data voltages supplied to the k data lines DLj1 through DLjk, based on the clock signals CLK and the output timing data OTD, respectively.

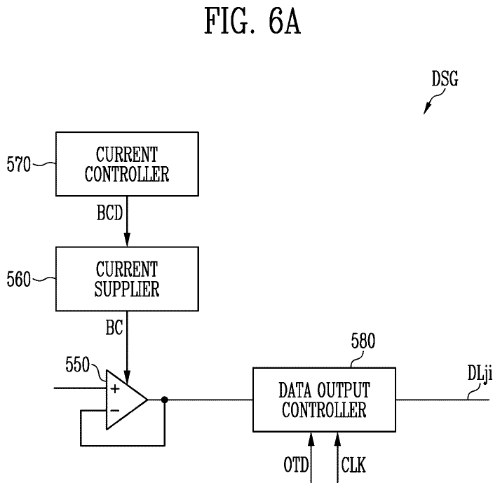

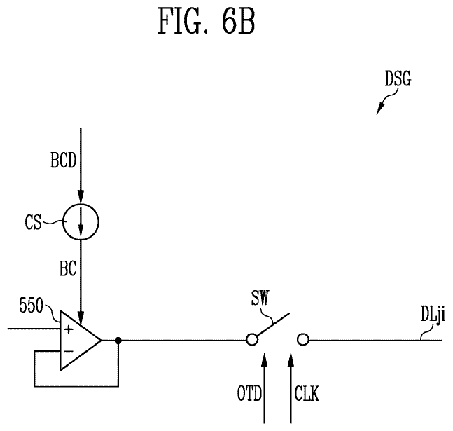

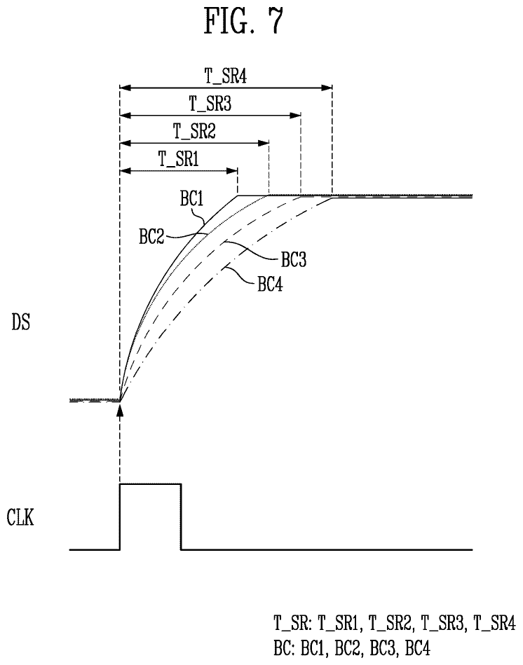

FIG. 6A illustrates an embodiment of the current controller, the current supplier, the output buffer, and the data output controller, which are examples of those shown in FIG. 5. FIG. 6B illustrates an embodiment of the current controller, the current supplier, the output buffer, and the data output controller, which are examples of those shown in FIG. 5. FIG. 7 illustrates waveforms of a data signal based on intensity of bias current. FIG. 8 illustrates waveforms of a data signal based on data output timing.

The output buffer 550 of FIG. 5 may supply a data signal DS to an ith data line DLji as any one of the data lines DLj via the data output controller 580.

The current controller 570 may supply bias current data BCD to the current supplier 560. The bias current data BCD may be data for determining an intensity of a bias current at a specific time point or in a specific period (e.g., one frame period). Accordingly, the current supplier 560 may supply a bias current BC having a predetermined intensity to the output buffer 550, based on the bias current data BCD.

The data output controller 580 may be supplied with a clock signal and output timing data. For example, the data output controller 580 may be supplied with the clock signal CLK and the output timing data OTD from the timing controller 410 (see FIG. 3, described supra).

A contact resistance may exist on the ith data line DLji. Accordingly, in a period in which the data signal DS is changed from a voltage having a first level to a voltage having a second level, a delay of the data signal DS may occur. For example, when the data signal DS is changed from the first level to the second level, a transition time for the data signal DS to be changed from the first level to the second level may vary based on an intensity of the contact resistance. In other words, a slew rate of the data signal DS may vary based on the intensity of the contact resistance.

Referring to FIGS. 6A and 7, the current controller 570 may control the slew rate of the data signal DS by outputting bias current data BCD for the current supplier 560 to adjust the intensity of the bias current BC. In other words, the slew rate of the data signal DS output by the output buffer 550 may be controlled based on the intensity of the bias current supplied by the current supplier 560. The slew rate of the data signal DS may be defined or expressed as a value in inverse proportion to the transition time for the data signal DS to be changed from the first level to the second level, such as a transition time T_SR. For example, when the intensity of the bias current BC is increased, the transition time T_SR of the data signal DS (e.g., a transition time for the data signal DS to be changed from the first level to the second level) may be shortened. That is, when the intensity of the bias current BC is increased, the slew rate of the data signal DA may be increased.

In an embodiment, when the clock signal CLK supplied to the data output controller 580 is changed from a low level to a high level, a data signal DS may be output. A first bias current BC1 may be greater than a second bias current BC2. Accordingly, a data signal DS generated based on the first bias current BC1 may be relatively rapidly charged as compared with a data signal DS generated based on the second bias current BC2, and a first transition time T_SR1 may be shorter than a second transition time T_SR2. That is, a slew rate of the data signal DS generated based on the first bias current BC1 may be greater than a slew rate of the data signal DS generated based on the second bias current BC2.

The second bias current BC2 may be greater than a third bias current BC3. Accordingly, the data signal DS generated based on the second bias current BC2 may be relatively rapidly charged as compared with a data signal DS generated based on the third bias current BC3, and the second transition time T_SR2 may be shorter than a third transition time T_SR3. That is, the slew rate of the data signal DS generated based on the second bias current BC2 may be greater than a slew rate of the data signal DS generated based on the third bias current BC3.

The third bias current BC3 may be greater than a fourth bias current BC4. Accordingly, the data signal DS generated based on the third bias current BC3 may be relatively rapidly charged as compared with a data signal DS generated based on the fourth bias current BC4, and the third transition time T_SR3 may be shorter than a fourth transition time T_SR4. That is, the slew rate of the data signal DS generated based on the third bias current BC3 may be greater than a slew rate of the data signal DS generated based on the fourth bias current BC4.

The data output controller 580 may control output timing of the data signal DS, based on the clock signal CLK and the output timing data OTD. For example, the data output controller 580 need not output the data signal DS to the ith data line DLji until a time point set by the supplied output timing data OTD. In other words, the data output controller 580 may be configured in a state in which a constant voltage is not applied to the ith data line DLji (e.g., a floating state) until the time point set by the supplied output timing data OTD. After that, the data output controller 580 may output the data signal DS to the ith data line DLji at or after the time point set by the supplied output timing data OTD.

Referring to FIGS. 6A and 8, a slew rate of a data signal DS may be controlled based on a time point at which the data output controller 580 outputs the data signal DS. For example, when the time point at which the data output controller 580 outputs the data signal DS is delayed, a transition time T_SR of the data signal DS may be shortened. That is, if the time point at which the data output controller 580 outputs the data signal DS is delayed, the slew rate of the data signal may be increased to achieve a shorter transition time.

The data output controller 580 may control an output time point of the data signal DS based on the supplied output timing data OTD. For example, the data output controller 580 may be supplied with first output timing data OTD1. The data output controller 580 may output the data signal at a first time point T, and the data signal DS may be changed to the second level during an eighth transition time T_SR8 from the first time point T1. In an embodiment, the data output controller 580 may be supplied with second output timing data OTD2. The data output controller 580 may output the data signal DS at a second time point T2, and the data signal DS may be changed to the second level during a seventh transition time T_SR7 from the second time point T2. That is, when the data signal DS is output at the second time point T2, the slew rate of the data signal DS may be relatively increased as compared with when the data signal DS is output at the first time point T1.

In still another embodiment, the data output controller 580 may be supplied with third output timing data OTD3. The data output controller 580 may output the data signal DS at a third time point T3, and the data signal DS may be changed to the second level during a sixth transition time T_SR6 from the third time point T3. That is, when the data signal DS is output at the third time point T3, the slew rate of the data signal DS may be relatively increased as compared with when the data signal DS is output at the second time point T2.

Further, the data output controller 580 may be supplied with fourth output timing data OTD4. The data output controller 580 may output the data signal DS at a fourth time point T4, and the data signal DS may be changed to the second level during a fifth transition time T_SR5 from the fourth time point T4. That is, when the data signal DS is output at the fourth time point T4, the slew rate of the data signal DS may be relatively increased as compared with when the data signal DS is output at the third time point T3.

A time interval between the first time point T1 and the second time point T2 may be smaller than a clock signal period CSC. In addition, a time interval between the second time point T2 and the third time point T3 may be smaller than the clock signal period CSC. Further, a time interval between the third time point T3 and the fourth time point T4 may be smaller than the clock signal period CSC. The clock signal period CSC may be a period in which the clock signal CLK is changed from the first level to the second level and is again changed from the second level to the first level. In an embodiment, the clock signal period CSC may span the first through fourth time points T1 through T4.

Referring to FIGS. 6A and 6B, in an embodiment, the data output controller 580 may include a switch SW. The switch SW may operate to be on or off, and control an output timing of the data signal DS. In addition, in an embodiment, the current supplier 560 may include a current source CS. However, the present disclosure is not limited thereto.

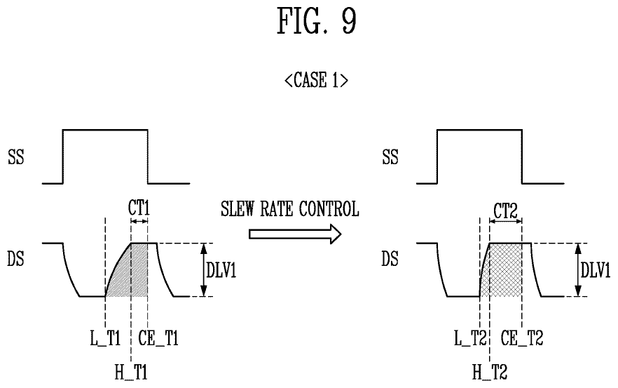

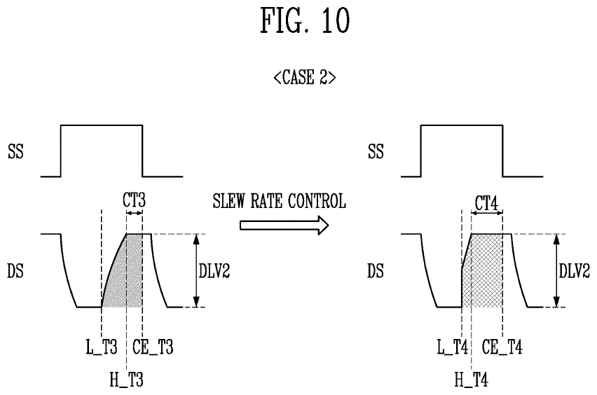

FIG. 9 illustrates a data slew rate control operation based on control of bias current. FIG. 10 illustrates a data slew rate control operation based on bias current and data signal output timing control.

Referring to FIGS. 7 through 10, a data signal DS synchronized with a scan signal SS may be supplied to the ith data line DLji (see FIG. 6A, described supra). In other words, the data signal DS, synchronized with a period in which the scan signal SS having a turn-on level is applied to a scan line, may be supplied to the ith data line DLji.

A first case CASE 1 may be described with respect to an embodiment in which a slew rate of the data signal is controlled by adjusting only the intensity of the bias current BC. For example, according to the first case CASE 1, a transition time for the data signal DS to be changed from the first level to the second level may be shortened by increasing the intensity of the bias current BC. In other words, a time between a second low time point L_T2 at which the data signal DS has the first level and a second high time point H_T2 at which the data signal DS is changed to the second level, in accordance with an embodiment in which the slew rate of the data signal is controlled, (hereinafter, referred to as an embodiment of the present disclosure) may be relatively shorter than a time between a first low time point L_T1 at which the data signal DS has the first level and a first high time point H_T1 at which the data signal DS is changed to the second level in accordance with an embodiment before the slew rate of the data signal DS is controlled (hereinafter, referred to as a comparative example). Accordingly, a second charging time CT2 (e.g., a time between the second high time point H_T2 and a second charging time point CE_T2), in accordance with this embodiment of the present disclosure, may be longer than a first charging time CT1 (e.g., a time between the first high time point H_T1 and a first charging time point CE_T1) in accordance with the comparative example. That is, in accordance with this embodiment of the present disclosure, charging of the data signal DS can be efficiently accomplished.

According to the first case CASE 1, a luminance value, which the pixels PXL of the display panel 100 (see FIG. 1, described supra) express, may be 1000 nits, and a maximum grayscale value of an image, which the display panel 100 displays, may be 186 G (gray). However, the present disclosure is not limited thereto.

Referring to FIGS. 7 through 10, a second case CASE 2 may be described with respect to an embodiment in which the slew rate of the data signal DS is controlled by adjusting both the intensity of the bias current BC and the output timing of the data signal DS. For example, according to the second case CASE2, a transition time for the data signal DS to transition from the first level to the second level may be shortened by increasing the intensity of the bias current BC and delaying the output timing of the data signal DS. For example, an output timing of the data signal DS in accordance with this embodiment of the present disclosure may be later than an output timing of the data signal DS in accordance with the comparative example. That is, a data signal at a fourth low time point L_T4 may have a relatively high level as compared with a data signal DS at a third low time point L_T3. In other words, a time interval between the fourth low time point L_T4 at which the data signal DS has the first level and a fourth high time point H_T4 at which the data signal DS reaches the second level in accordance with this embodiment of the present disclosure may be relatively shorter than a time interval between the third low time point L_T3 at which the data signal DS has the first level and a third high time point H_T3 at which the data signal reaches the second level in accordance with the comparative example. Accordingly, a fourth charging time CT4 (e.g., a time between the fourth high time point H_T4 and a fourth charging time point CE_T4) in accordance with this embodiment of the present disclosure may be longer than a third charging time CT3 (e.g., a time between a third charging time point CE_T3 and the third high time point H_T3) in accordance with the comparative example. That is, in accordance with this embodiment of the present disclosure, charging of the data signal DS can be efficiently accomplished.

According to the second case CASE 2, a luminance value which the pixels PXL of the display panel 100 (see FIG. 1, described supra) express may be 2000 nits, and a maximum grayscale value of an image which the display panel 100 displays may be 255 G corresponding to a maximum grayscale. However, the present disclosure is not limited thereto.

As the maximum grayscale value of an image becomes higher, a difference between a first level voltage and a second level voltage of the data signal DS may become larger. For example, a difference DLV2 between a first level voltage and a second level voltage of the data signal according to the second case CASE 2 may be greater than a difference DLV1 between a first level voltage and a second level voltage of the data signal according to the first case CASE 1. Accordingly, a risk that a charging time of the data signal DS is relatively insufficient may increase as the maximum grayscale value of an image becomes higher.

In accordance with this embodiment of the present disclosure, like the second case CASE 2, when the intensity of the bias current BC and the output timing of the data signal DS are simultaneously controlled, a charging time of the data signal DS can be further secured. Accordingly, the quality of an image which the display device 1000 (see FIG. 1, discussed supra) display may be further optimized.

In an alternate embodiment, features of the illustrative embodiment described with respect to FIG. 4 may be combined with features of the illustrative embodiment described with respect to FIG. 10. For example, the timing controller of FIG. 10 may be further configured to supply frame data to the data drivers, where the frame data includes a data slew rate option based on a maximum grayscale value expressed through the pixel blocks.

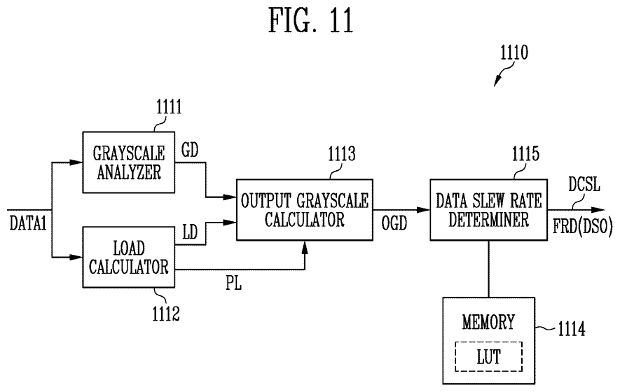

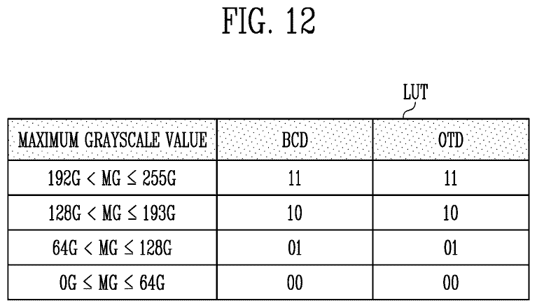

FIG. 11 illustrates a timing controller in accordance with an embodiment of the present disclosure. FIG. 12 illustrates an embodiment of a lookup table shown in FIG. 11.

Referring to FIG. 11, the timing controller 1110 may include a grayscale analyzer 1111, a load calculator 1112, an output grayscale calculator 1113, a memory 1114, and a data slew rate determiner 1115. The timing controller 1110 shown in FIG. 11 may be a component corresponding to the timing controller 410 shown in FIG. 2, without limitation thereto.

The grayscale analyzer 1111 may be supplied with input image data DATA1 from an external source, such as a processor. The grayscale analyzer 1111 may generate an input grayscale value GD to be input to each data driver IC 310 (see FIG. 2, described supra), based on the input image data DATA1. The grayscale analyzer 1111 may transfer the generated input grayscale value GD to the output grayscale calculator 1113. In an embodiment, the input grayscale value GD may be different from a grayscale value of an image output from a pixel block of the display panel 100 (see FIG. 1, described supra).

The load calculator 1112 may be supplied with the input image data DATA1 from the external source. The load calculator 1112 may generate an input luminance value PL and a load value LD, which are to be supplied to each data driver IC 310. The load calculator 1112 may transfer the generated input luminance value PL and the generated load value LD to the output grayscale calculator 1113.

The load value LD may indicate a ratio of pixels PXL (see FIG. 1, described supra) emitting light in the display panel 100. That is, when the display panel 100 emits light with full white (e.g., when all the pixels PXL in the display panel 100 emit light with a luminance corresponding to white), the load value LD may be set to 100%. The load calculator 1112 may set a load limit value having a value obtained by multiplying the input luminance value PL by the load value LD. Accordingly, the display panel 100 may be driven to have a constant driving current based on the load limit value. For example, the pixels PXL of the display panel 100 may be driven based on the load limit value set by the load calculator 1112, and the driving current of the display panel 100 may be consistently maintained. Accordingly, the power consumption of the display device 1000 (see FIG. 1) can be relatively reduced.

Referring to FIGS. 11 and 12, the output grayscale calculator 1113 may receive the input grayscale value GD, the input luminance value PL, and the load value LD. For example, the output grayscale calculator 1113 may generate output grayscale data OGD, based on the input grayscale value GD, the input luminance value PL, and the load value LD. The output grayscale data OGD may include information on a maximum grayscale value MG of an image which the display panel 100 displays. The maximum grayscale value MG of the image may be in inverse proportion to the input grayscale value GD. In addition, the maximum grayscale value MG of the image may be in inverse proportion to the input luminance value PL. Further, the maximum grayscale value MG of the image may be in inverse proportion to the load value LD. Accordingly, the output grayscale calculator 1113 may transfer the output grayscale data OGD to the data slew rate determiner 1115.

Referring to FIGS. 11 and 12, a lookup-table LUT may be stored in the memory 1114. The slew rate determiner 1115 may read data included in the lookup table LUT from the memory 1114.

The lookup table LUT may include bias current data BCD and output timing data OTD. For example, the lookup table LUT may include bias current data BCD and output timing data OTD, each of which corresponds to a maximum grayscale value MG of an image. In this illustrative example, each of the bias current data BCD and the output timing data OTD may have a value of 00, 01, or 11 based on the maximum grayscale value MG of the image, without limitation thereto. Each of 00, 01, 10, and 11 may be expressed using a binary system, and 00, 01, 10, and 11 may respectively correspond to 0, 1, 2, and 3 which are expressed using a decimal system.

The data slew rate determiner 1115 may acquire bias current data BCD and output timing data OTD, which correspond to the output grayscale data OGD. For example, the data slew rate determiner 1115 may extract a maximum grayscale value MG of an image, which corresponds to the output grayscale data OGD. After that, the data slew rate determiner 1115 may acquire bias current data BCD and output timing data OTD, which correspond to the maximum grayscale value MG of the image, from the lookup table LUT of the memory 1114. Accordingly, the data slew rate determiner 1115 may generate a data slew rate option DSO including the acquired bias current data BCD and the acquired output timing data OTD. In other words, the data slew rate determiner 1115 may generate a data slew rate option DSO based on the maximum grayscale value MG, and the generated data slew rate option DSO may be included in frame data FRD. Moreover, the data slew rate determiner 1115 may transfer the frame data FRD to the data driver 300 (see FIG. 2, described supra), or to the data driver IC 310 (ld.) through a data clock signal line DCSL.

In an embodiment, when the maximum grayscale value MG of the image is between about 0 G or more and 64 G or less, the bias current data BCD included in the data slew rate option DSO may have a value of 00, and the output timing data OTD included in the data slew rate option DSO may also have the value of 00. For example, when the bias current data BCD has the value of 00, the current controller 570 may adjust the bias current BC as the first bias current BC1. In addition, when the output timing data OTD has the value of 00, the data output controller 580 may output the data signal DS at the first time point T1. In accordance with an embodiment, when the maximum grayscale

value MG of the image is between about 64 G or more and 128 G or less, the bias current data BCD included in the data slew rate option DSO may have a value of 01, and the output timing data OTD may also have the value of 01. When the bias current data BCD has the value of 01, the current controller 570 may adjust the bias current BC as the second bias current BC2. In addition, when the output timing data OTD has the value of 01, the data output controller 580 may output the data signal DS at the second time point T2.

In accordance with another embodiment, when the maximum grayscale value MG of the image is between about 128 G or more and 192 G or less, the bias current data BCD included in the data slew rate option DSO may have a value of 10, and the output timing data OTD may also have the value of 10. When the bias current data BCD has the value of 10, the current controller 570 may adjust the bias current BC as the third bias current BC3. In addition, when the output timing data OTD has the value of 10, the data output controller 580 may output the data signal DS at the third time point T3.

In accordance with still another embodiment, when the maximum grayscale value MG of the image is between about 192 G or more and 255 G or less, the bias current data BCD included in the data slew rate option DSO may have a value of 11, and the output timing data OTD may also have the value of 11. When the bias current data BCD has the value of 11, the current controller 570 may adjust the bias current BC as the fourth bias current BC4. In addition, when the output timing data OTD has the value of 11, the data output controller 580 may output the data signal DS at the fourth time point T4.

The difference between the first level voltage and the second level voltage may become larger as the maximum grayscale value MG of the image becomes higher. Accordingly, a risk may increase that the charging time of the data signal DS is relatively insufficient.

In accordance with this embodiment of the present disclosure, as the maximum grayscale value MG of the image becomes higher, the current controller 570 may be controlled to supply a relatively larger bias current BC. In addition, as the maximum grayscale value MG of the image becomes higher, the data output controller 580 may output the data signal DS relatively later (e.g., at the fourth time point T4). Accordingly, although the maximum grayscale value MG of the image is high, the current controller 570 and the data output controller 580 may be driven to relatively decrease the transition time T_SR of the data signal DS. In other words, when the maximum grayscale value MG of the image is high, the current controller 570 and the data output controller 580 may relatively increase the slew rate of the data signal DS. Accordingly, the charging time of the data signal DS can be relatively increased, and the display device 1000 (see FIG. 1, described supra) can be driven with optimized reliability.

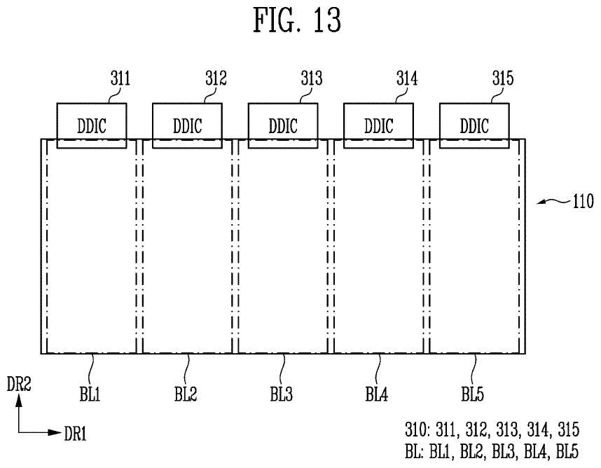

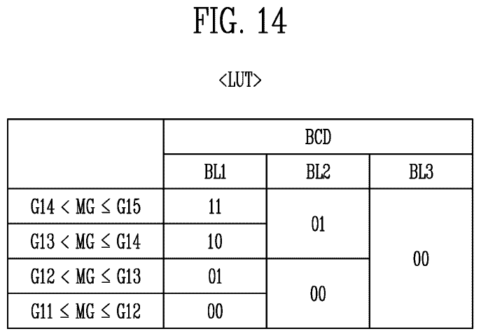

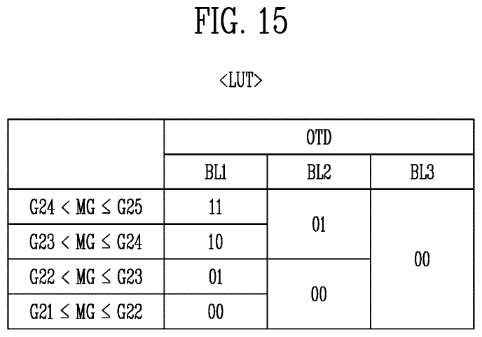

FIG. 13 illustrates pixel blocks corresponding to the data driver ICs in accordance with an embodiment of the present disclosure. FIG. 14 illustrates an embodiment of the bias current data included in the lookup table shown in FIG. 12. FIG. 15 illustrates an embodiment of the output timing data included in the lookup table shown in FIG. 12.

Referring to FIG. 13, the display area 110 may include pixel blocks BL. For example, the pixel blocks BL may include first through fifth pixel blocks BL1 through BL5 arranged in one direction. Each of the pixel blocks BL may include at least one pixel PXL (see FIG. 1, described supra). Although five pixel blocks BL are illustrated in the embodiment of FIG. 13, the present disclosure is not limited thereto.

The pixel blocks BL may be connected to the data lines DL in the display area 110 or the display panel 100. See FIG. 1. For example, each of the first through fifth pixel blocks BL1 through BL5 may be connected to a corresponding data driver sub-circuit among first through fifth data driver sub-circuits 311 through 315 via the data line DL.

The first pixel block BL1 may be disposed adjacent to any corner of the display area 110 or the display panel 100. The third pixel block BL3 may be disposed at a central portion of the display area 110. The second pixel block BL2 may be disposed between the third pixel block BL3 and the first pixel block BL1. The fourth pixel block BL4 may be disposed between the third pixel block BL3 and the fifth pixel block BL5.

Charging rates of the data signal DS (see FIG. 10, described supra) of the first through fifth pixel blocks BL1 through BL5 may be different from each other. In other words, based on positions of the first through fifth pixel blocks BL1 through BL5 on the display area 110, the charging rates of the data signal DS (see FIG. 10) may be different from each other. For example, a charging rate of the data signal DS of the first pixel block BL1 disposed at an outer portion of the display area 110 may be relatively low as compared with a charging rate of the data signal DS of the third pixel block BL3 disposed at the central portion of the display area 110. Thus, a charging time of the data signal DS supplied to the first pixel block BL1 might otherwise be insufficient. Accordingly, a slew rate of the data signal DS of the first pixel block BL1 having a relatively low charging rate should be relatively high.

The at least one data driver IC 310 may individually drive corresponding pixel blocks BL. For example, the first through fifth data driver sub-circuits 311 through 315 may control and/or drive the first through fifth pixel blocks BL1 through BL5, respectively. In an embodiment, maximum grayscale values MG of an image which the first through fifth pixel blocks BL1 through BL5 express may be different from each other.

Referring to FIGS. 13 through 15, bias current data BCD supplied to the first through third data driver sub-circuits 311 through 313 respectively corresponding to the first through third pixel blocks BL1 through BL3 may be included in the lookup table LUT. Output timing data OTD supplied to the first through third data driver sub-circuits 311 through 313 respectively corresponding to the first through third pixel blocks BL1 through BL3 may be included in the lookup table LUT. The bias current data BCD and the output timing data OTD of the lookup table LUT may be included in the data slew rate option DSO (see FIG. 11, described supra) to be supplied to the first through third data driver sub-circuits 311 through 313.

In an alternate embodiment, features of the illustrative embodiment described with respect to FIG. 4 may be combined with features of the illustrative embodiment described with respect to FIG. 13. For example, the timing controller of FIG. 13 may be further configured to supply frame data to the data drivers, where the frame data includes a data slew rate option based on positions of the pixel blocks relative to the display panel.

In an alternate embodiment, features of the illustrative embodiment described with respect to FIG. 4 may be combined with features of the illustrative embodiments described with respect to FIG. 10 and FIG. 13. For example, the timing controller of FIG. 13 may be further configured to supply frame data to the data drivers, where the frame data includes a data slew rate option based on a maximum grayscale value expressed through the pixel blocks and positions of the pixel blocks relative to the display panel.

In FIGS. 14 and 15, for convenience of description, bias current data BCD and output timing data OTD are illustrated, such as are supplied to the first through third data driver sub-circuits 311 through 313 respectively corresponding to the first through third pixel blocks BL1 through BL3. However, the present disclosure is not limited thereto.

In an embodiment, the first pixel block BL1 and the first data driver sub-circuit 311 may correspond to the fifth pixel block BL5 and the fifth data driver sub-circuit 315. In addition, the second pixel block BL2 and the second data driver sub-circuit 312 may correspond to the fourth pixel block BL4 and the fourth data driver sub-circuit 314.

Referring to FIGS. 12 through 14, when the maximum grayscale value MG of the image is between about an eleventh value G11 and a twelfth value G12, the bias current data BCD supplied to the first data driver sub-circuit 311 may have the value of 00. In an example, when the maximum grayscale value MG of the image is between about the twelfth value G12 and a thirteenth value G13, the bias current data BCD supplied to the first data driver sub-circuit 311 may have the value of 01. In another example, when the maximum grayscale value MG of the image is between about the thirteenth value G13 and a fourteenth value G14, the bias current data BCD supplied to the first data driver sub-circuit 311 may have the value of 10. In still another example, when the maximum grayscale value MG of the image is between about the fourteenth value G14 and a fifteenth value G15, the bias current data BCD supplied to the first data driver sub-circuit 311 may have the value of 11.

In accordance with another embodiment, when the maximum grayscale vale MG of the image is between about the eleventh value G11 and the thirteenth value G13, the bias current data BCD supplied to the second data driver sub-circuit 312 may have the value of 00. In another example, when the maximum grayscale vale MG of the image is between about the thirteenth value G13 and the fifteenth value G15, the bias current data BCD supplied to the second data driver sub-circuit 312 may have the value of 01.

In accordance with still another embodiment, when the maximum grayscale vale MG of the image is between about the eleventh value G11 and the fifteenth value G15, the bias current data BCD supplied to the third data driver sub-circuit 313 may have the value of 00.

Referring to FIGS. 13 through 15, when the maximum grayscale vale MG of the image is between about a twenty-first value G21 and a twenty-second value G22, the output timing data OTD supplied to the first data driver sub-circuit 311 may have the value of 00. In another example, when the maximum grayscale vale MG of the image is between about the twenty-second value G22 and a twenty-third value G23, the output timing data OTD supplied to the first data driver sub-circuit 311 may have the value of 01. In still another example, when the maximum grayscale vale MG of the image is between about the twenty-third value G23 and a twenty-fourth value G24, the output timing data OTD supplied to the first data driver sub-circuit 311 may have the value of 10. In still another example, when the maximum grayscale vale MG of the image is between about the twenty-fourth value G24 and a twenty-fifth value G25, the output timing data OTD supplied to the first data driver sub-circuit 311 may have the value of 11.

In accordance with another embodiment, when the maximum grayscale vale MG of the image is between about the twenty-first value G21 and the twenty-third value G23, the output timing data OTD supplied to the second data driver sub-circuit 312 may have the value of 00. In another example, when the maximum grayscale vale MG of the image is between about the twenty-third value G23 and the twenty-fifth value G25, the output timing data OTD supplied to the second data driver sub-circuit 312 may have the value of 01.

In accordance with still another embodiment, when the maximum grayscale vale MG of the image is between about the twenty-first value G21 and the twenty-fifth value G25, the output timing data OTD supplied to the third data driver sub-circuit 313 may have the value of 00.

The twenty-first value G21, the twenty-second value G22, the twenty-third value G23, the twenty-fourth value G24, and the twenty-fifth value G25, which are shown in FIG. 15, may be values different from the eleventh value G11, the twelfth value G12, the thirteenth value G13, the fourteenth value G14, and the fifteenth value G15, which are shown in FIG. 14. However, the present disclosure is not limited thereto. For example, the twenty-first value G21 shown in FIG. 15 may be substantially equal to the eleventh value G11 shown in FIG. 14.

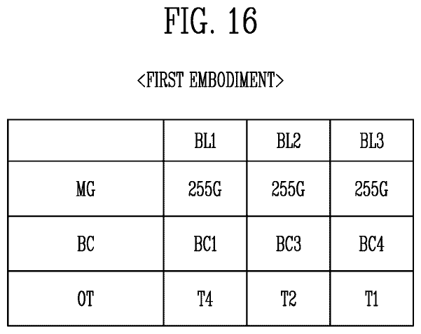

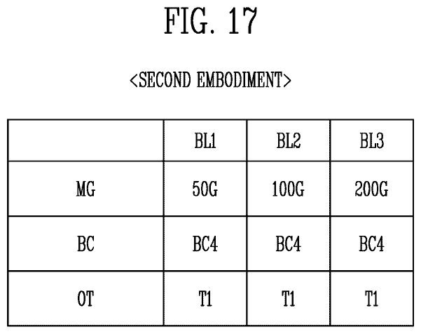

FIG. 16 illustrates an embodiment with bias currents and output timings of a data signal based on maximum grayscale values of first through third pixel blocks. FIG. 17 illustrates an embodiment with the bias currents and the output timings of the data signal based on the maximum grayscale values of the first through third pixel blocks.

Referring to FIG. 16, in an embodiment, the maximum grayscale value MG of each of the first through third pixel blocks BL1 through BL3 may be 255 G. However, the present disclosure is not limited thereto.

Referring to FIGS. 13 through 16, a bias current BC generated in the first data driver sub-circuit 311 corresponding to the first pixel block BL1 may be the first bias current BC1. An output time point OT at which the first data driver sub-circuit 311 outputs the data signal DS to the first pixel block BL1 based on the first bias current BC1 may be the fourth time T4.

In addition, a bias current BC generated in the second data driver sub-circuit 312 corresponding to the second pixel block BL2 may be the third bias current BC3. An output time point OT at which the second data driver sub-circuit 312 outputs the data signal DS to the second pixel block BL2 based on the third bias current BC3 may be the second time T2.

Further, a bias current BC generated in the third data driver sub-circuit 313 corresponding to the third pixel block BL3 may be the fourth bias current BC4. An output time point OT at which the third data driver sub-circuit 313 outputs the data signal DS to the third pixel block BL3 based on the fourth bias current BC4 may be the first time T1.

Referring to FIG. 17, in an embodiment, a maximum grayscale value MG of the first pixel block BL1 may be 50 G. A maximum grayscale value MG of the second pixel block BL2 may be 100 G. A maximum grayscale value MG of the third pixel block BL3 may be 200 G. However, the present disclosure is not limited thereto.

Referring to FIGS. 13 through 17, a bias current BC generated in the first data driver sub-circuit 311 corresponding to the first pixel block BL1 may be the fourth bias current BC4. An output time OT at which the first data driver sub-circuit 311 outputs the data signal DS to the first pixel block BL1 based on the fourth bias current BC4 may be the first time point T1.

In addition, a bias current BC generated in the second data driver sub-circuit 312 corresponding to the second pixel block BL2 may be the fourth bias current BC4. An output time OT at which the second data driver sub-circuit 312 outputs the data signal DS to the second pixel block BL2 based on the fourth bias current BC4 may be the first time point T1.

Further, a bias current BC generated in the third data driver sub-circuit 313 corresponding to the third pixel block BL3 may be the fourth bias current BC4. An output time OT at which the third data driver sub-circuit 313 outputs the data signal DS to the third pixel block BL3 based on the fourth bias current BC4 may be the first time point T1.

In accordance with this embodiment of the present disclosure, the slew rate of the data signal DS may be adaptively controlled based on the positions of the pixel blocks BL and the maximum grayscale values MG of the image. For example, the slew rate of the data signal DS supplied to the first pixel block BL1 having a relatively low charging rate of the data signal DS as compared with the second pixel block BL2 may be controlled as relatively high. In addition, the slew rate of the data signal DS supplied to the first pixel block BL1 may be individually controlled based on the maximum grayscale value MG of the first pixel block BL1. In addition, the slew rate of the data signal DS supplied to the second pixel block BL2 having a relatively low charging rate of the data signal DS as compared with the third pixel block BL3 may be controlled as relatively high. Moreover, the slew rate of the data signal DS supplied to the second pixel block BL2 may be individually controlled based on the maximum grayscale value MG of the second pixel block BL2. In other words, the slew rate of the data signal DS may be controlled by considering both the maximum grayscale value MG of the image as well as the positions of the pixel blocks BL. Accordingly, the quality of an image which the display device 1000 (see FIG. 1) displays may be optimized.

In addition, referring to FIGS. 13 through 17, when the charging rate of the data signal DS is relatively stable (e.g., when the maximum grayscale value MG is relatively low or when a pixel block BL is located near the central portion of the display area 110), the slew rate of the data signal DS may be controlled as relatively low. Accordingly, the power consumption of the display device 1000 can be reduced.

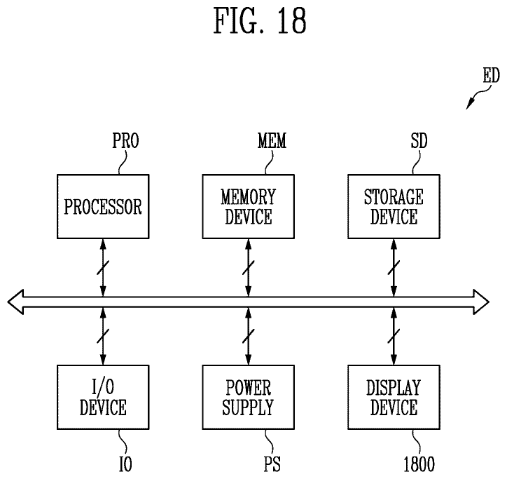

FIG. 18 illustrates an electronic device including a display device in accordance with an embodiment of the present disclosure.

Referring to FIG. 18, the electronic device ED may include a processor PRO, a memory device MEM, a storage device SRD, an input/output (I/O) device IO, a power supply, PS, and a display device 1800. The display device 1800 may be the display device 1000 shown in FIG. 1. In addition, the electronic device ED may further include several ports capable of communicating with a video card, a sound card, a memory card, a USB device, and the like, or communicating with other systems. In an embodiment, the electronic device ED may be implemented as a tablet PC. In another embodiment, the electronic device ED may be implemented as a tablet PC. However, this is merely illustrative, and the electronic device ED is not limited thereto. For example, the electronic device ED may be implemented as a mobile phone, a video phone, a smart pad, a smart watch, a vehicle navigation system, a computer monitor, a notebook computer, a head mounted display device, or the like.

The processor PRO may perform specific calculations or tasks. In an embodiment, the processor PRO may be a microprocessor, a central processing unit, an application processor, or the like. The processor PRO may be connected to other components through an address bus, a control bus, a data bus, and the like. In an embodiment, the processor PRO may be connected to an extension bus such as a peripheral component interconnect (PCI) bus.

In an embodiment, the processor PRO may transfer a signal for a data slew rate option DSO (see FIG. 11) to the display device 1800. For example, the processor PRO may supply, to the timing controller 410 (see FIG. 1), frame data FRD (see FIG. 11) including the data slew rate option DSO. The processor PRO may determine a data slew rate option DSO determined based on a maximum grayscale value MG (see FIG. 12) of an image which the display device 1800 displays and positions of pixel blocks BL (see FIG. 13). After that, the processor PRO may supply, to the timing controller 410, frame data FRD including the determined data slew rate option DSO. Accordingly, the timing controller 410 may supply the frame data FRD to the at least one data driver IC 310 (see FIG. 13), and each of the data driver sub-circuits may individually control data slew rates of a plurality of pixel blocks BL.

The memory device MEM may store data necessary for an operation of the electronic device ED. For example, the memory device MEM may include a nonvolatile memory device such as an Erasable Programmable Read-Only Memory (EPROM) device, an Electrically Erasable Programmable Read-Only Memory (EEPROM) device, a flash memory device, a Phase Change Random Access Memory (PRAM) device, a Resistance Random Access Memory (RRAM) device, a Nano Floating Gate Memory (NFGM) device, a Polymer Random Access Memory (PoRAM) device, a Magnetic Random Access Memory (MRAM) device, or a Ferroelectric Random Access Memory (FRAM) device, and/or a volatile memory device such as a Dynamic Random Access Memory (DRAM) device, a Static Random Access Memory (SRAM) device, or a mobile DRAM device.

The storage device SRD may include a Solid State Drive (SSD), a Hard Disk Drive (HDD), a CD-ROM, and the like.

The I/O device IO may include an input means such as a keyboard, a keypad, a touch screen, or a mouse, and an output means such as a speaker or a printer. In an embodiment, the display device 1800 may be included in the I/O device IO.

The power supply PS may supply power necessary for an operation of the electronic device ED. For example, the power supply PS may be a power management integrated circuit (PMIC).

The display device 1800 may display an image corresponding to visual information of the electronic device ED. The display device 1800 may be an organic light emitting display device or a quantum dot light emitting display device, but the present disclosure is not limited thereto. The display device 1800 may be connected to other components through the buses or another communication link.

In accordance with the present disclosure, the intensity of a bias current and the output timing of a data signal, supplied to an output buffer, based on positions of pixel blocks on a display panel and a maximum grayscale value of an image which the pixel blocks actually output, can be controlled. Accordingly, a data slew rate of a pixel block having a relatively low data charging rate is increased, thereby optimizing the image quality of the display device.

In addition, in accordance with the present disclosure, the data slew rate of a pixel block having a sufficient data charging rate is relatively lowered, thereby reducing the power consumption of the display device.

Illustrative embodiments have been disclosed herein, and although specific terms are employed, they are used and are to be interpreted in a generic and descriptive sense only and not for purposes of limitation. In some instances, as would be apparent to one of ordinary skill in the pertinent art as of the effective filing date of the present application, features, characteristics, and/or elements described in connection with a particular embodiment may be used singly or in combination with features, characteristics, and/or elements described in connection with any other embodiments unless otherwise specifically indicated. Accordingly, it will be understood by those of ordinary skill in the pertinent art that various changes in form and details may be made without departing from the scope and spirit of the present disclosure as set forth in the following claims.

What is claimed is:

1. A display device comprising:
a display panel including data lines and pixel blocks connected to the data lines;
data drivers configured to supply data signals to the data lines; and
a timing controller configured to control the data drivers,
wherein each of the data drivers is configured to adjust slew rates of the data signals, based on a maximum grayscale value of input image data to be displayed through the pixel blocks and positions of the pixel blocks relative to the display panel, and
wherein the timing controller is configured to calculate the maximum grayscale value of the image, based on an input grayscale value of the input image data, an input luminance value of the input image data, and a load value of each of the pixel blocks.

2. The display device of claim 1, wherein each of the data drivers includes:
an output buffer configured to output any one of the data signals to any one of the data lines;
a current supplier configured to supply a bias current to the output buffer;
a current controller configured to adjust an intensity of the bias current, based on the maximum grayscale value of the image; and
a data output controller configured to adjust an output timing of any one of the data signals, based on the maximum grayscale value of the image.

3. The display device of claim 2,
wherein the current controller increases the intensity of the bias current as the maximum grayscale value becomes larger, and
wherein the data output controller delays the output timing of any one of the data signals as the maximum grayscale value becomes larger.

4. The display device of claim 2, wherein the pixel blocks include:
a first pixel block disposed adjacent to a corner of the display panel; and
a second pixel block disposed adjacent to the first pixel block, and
wherein the maximum grayscale value of each of the first pixel block and the second pixel block has any one of a first grayscale value, a second grayscale value, and a third grayscale value.

5. The display device of claim 4,
wherein the current controller is configured to supply any one of a first bias current, a second bias current, and a third bias current to each of a first output buffer corresponding to the first pixel block and a second output buffer corresponding to the second pixel block, and
wherein the data output controller outputs the data signals supplied to the first pixel block and the second pixel block at any one of a first time point, a second time point, and a third time point.

6. The display device of claim 5, wherein, when the maximum grayscale value of the first pixel block is the first grayscale value,
the current controller is configured to supply the first bias current to the first output buffer, and
the data output controller outputs the data signal supplied to the first pixel block at the first time point.

7. The display device of claim 5, wherein, when the maximum grayscale value of the first pixel block is the second grayscale value greater than the first grayscale value,
the current controller is configured to supply the second bias current greater than the first bias current to the first output buffer, and
the data output controller outputs the data signal supplied to the first pixel block at the second time point later than the first time point.

8. The display device of claim 5, wherein, when the maximum grayscale value of the first pixel block is a third grayscale value greater than the second grayscale value,
the current controller is configured to supply the third bias current greater than the second bias current to the first output buffer, and
the data output controller outputs the data signal supplied to the first pixel block at the third time point later than the second time point.

9. The display device of claim 7, wherein, when the maximum grayscale value of the second pixel block is the second grayscale value,
the current controller is configured to supply the first bias current to the second output buffer, and
the data output controller outputs the data signal supplied to the second pixel block at the first time point.

10. The display device of claim 8, wherein, when the maximum grayscale value of the second pixel block is the third grayscale value,
the current controller is configured to supply the second bias current to the second output buffer, and
the data output controller outputs the data signal supplied to the second pixel block at the second time point.

11. The display device of claim 5,
wherein the pixel blocks further include a third pixel block disposed more adjacent to the first pixel block than the second pixel block, and
wherein the data drivers independently control the first to third pixel blocks.

12. The display device of claim 11,
wherein the current controller is configured to supply the first bias current to a third output buffer corresponding to the third pixel block, and
wherein the data output controller outputs the data signal supplied to the third pixel block at the first time point.

13. The display device of claim 1, wherein the timing controller calculates the maximum grayscale value to be in inverse proportion to the input grayscale value, the input luminance value, and the load value.

14. A display device comprising:
a display panel including data lines and pixel blocks connected to the data lines;
data drivers configured to supply data signals to the data lines; and
a timing controller configured to supply frame data to the data drivers,
wherein the frame data includes a data slew rate option based on a maximum grayscale value expressed through the pixel blocks and positions of the pixel blocks relative to the display panel.

15. The display device of claim 14, wherein the timing controller includes:
a grayscale analyzer configured to calculate an input grayscale value of each of the pixel blocks, based on input image data; and
a load calculator configured to calculate an input luminance value and a load value of each of the pixel blocks, based on the input image data.

16. The display device of claim 15, wherein the timing controller further includes an output grayscale calculator configured to calculate the maximum grayscale value, based on the input grayscale value, the input luminance value, and the load value, of each of the pixel blocks.

17. The display device of claim 16, wherein the output grayscale calculator calculates the maximum grayscale value to be in inverse proportion to the input grayscale value, the input luminance value, and the load value.

18. The display device of claim 14, wherein the timing controller includes:
a memory configured to store a lookup table including bias current data supplied to the data lines and output timing data of the data signals; and
a data slew rate determiner configured to determine a data slew rate option corresponding to the maximum grayscale value, based on the lookup table.

19. The display device of claim 18, wherein each of the data drivers includes:
an output buffer configured to output any one of the data signals to any one of the data lines;
a current supplier configured to supply a bias current to the output buffer;
a current controller configured to adjust an intensity of the bias current, based on the data slew rate option; and
a data output controller configured to adjust an output timing of any one of the data signals, based on the data slew rate option.

20. An electronic device comprising:
a processor configured to provide a display device with a digital signal including frame data; and
a display device configured to display an image, based on the digital signal,
wherein the display device includes:
a display panel including data lines and pixel blocks connected to the data lines; and
data drivers configured to supply data signals to the data lines, and
wherein the frame data includes a data slew rate option based on a maximum grayscale value of an image expressed through the pixel blocks and positions of the pixel blocks relative to the display panel.
